(19) United States
(12) Patent Application Publication
(10) Pub. No.: US 2003/0214267 A1
(43) Pub. Date: Nov. 20, 2003

(54) Ultracapacitor balancing circuit

(76) Inventor: Laurence P. Long, Bethesda, MD (US)

Correspondence Address: JAGTIANI + GUTTAG, 10363-A DEMOCRACY LANE, FAIRFAX, VA, 22030, US

(21) Appl. No.: 10/441,017

(22) Filed: May 20, 2003

Related U.S. Application Data
(60) Provisional application No. 60/381,530, filed on May 20, 2002.

(51) Int. Cl. H02J 7/00

(52) U.S. Cl. 320/116

(57) ABSTRACT

The present invention provides an energy storage system comprising at least one voltage source, and a string of series connected cells, wherein each of the cells is connected to a circuit, wherein the circuit comprises at least one voltage reference, at least one voltage divider, which sets a trip point, and at least one operational amplifier, wherein at least one operational amplifier receives a first input from voltage reference and a second input from voltage divider and shunts an output through a power dissipative device when voltage of a cell exceeds said trip point.

### CROSS-REFERENCE TO RELATED APPLICATIONS

This application claims the priority of U.S. Provisional Patent Application No. 60/381,530, entitled “Ultracapacitor Balancing Circuit,” filed on May 20, 2002. The entire disclosure and contents of the above application is hereby incorporated by reference.

### BACKGROUND OF THE INVENTION

1. Field of the Invention

The present invention relates generally to an energy storage device, and more particularly to a method and device for equalizing leakage currents of a series of cells.

2. Description of the Prior Art

An ultracapacitor cell, supercapacitor cell, or capacitor cell may be used in circuits that operate above an individual cell's maximum rating. Cells in such a circuit typically do not have a tolerance for indefinite or prolonged operation above the cells' maximum rating. Operating beyond a cell's maximum rating can cause an internal breakdown leading to a device failure.

A typical method for increasing the working voltage of several cells is to connect one or more cells in a series. When cells are connected in series, voltage across each cell initially divides according to its capacitance value. If these cells in series do not have closely matched impedances or if manufacturing problems exist, they may have different leakage currents. After a period of time, an individual cell's voltage becomes a function of the leakage current, and a cell with a higher leakage current will have a lower voltage. This may cause the voltages across the individual cells to become uneven, potentially causing excessive voltage on one or more cells. This excessive voltage can cause the entire series of cells to fail.

Prior attempts of balancing or equalizing ultracapacitors use passive techniques, such as placing a fixed resistor across the cell terminals. One difficulty in connecting a large series of ultracapacitors is accommodating mismatch in electrical parameters, specifically the capacitance and leakage current. Thus, there is still a need for device or method that will accommodate mismatched electrical parameters.

### SUMMARY OF THE INVENTION

It is therefore an object of the present invention to provide a circuit that will accommodate mismatches in electrical parameters, such as capacitance and leakage current, in a string of series connected cells.

It is a further object of the present invention to provide a circuit that is powered directly from a cell or a string of series connected cells without the use of a direct current-to-direct current converter or external power source.

It is yet another object of the present invention to provide a circuit used to balance a large series string of cells which will provide an extremely low quiescent current, i.e. less than 50 microamperes.

Finally, it is an object of the present invention to provide a circuit connected to a cell in a string of cells that provides the cell a strong non-linearity in parallel resistance with respect to voltage.

According to a first broad aspect of the present invention, there is provided an energy storage system comprising at least one voltage source, and a string of series connected cells, wherein each of the cells is connected to a circuit, wherein the circuit comprises at least one voltage reference, at least one voltage divider, which sets a trip point, and at least one operational amplifier, wherein at least one operational amplifier receives a first input from voltage reference and a second input from voltage divider and shunts an output through a power dissipative device when voltage of a cell exceeds the trip point.

According to a second broad aspect of the present invention, there is provided an energy storage system comprising at least one voltage source, and a string of series connected cells, wherein each of the cells is connected to a circuit, wherein the circuit comprises at least one voltage reference, at least one voltage divider, which sets a trip point, and at least one comparator, wherein at least one comparator receives a first input from voltage reference and a second input from voltage divider and shunts an output bleed current through a power dissipative device when voltage of a cell exceeds the trip point.

According to third broad aspect of the invention, there is provided a method for accommodating mismatched capacitances of a string of series connected cells comprising the steps of setting a trip point that is lower than maximum rated voltage of the cell, and bleeding energy from the cell when said voltage across the cell exceeds the trip point, wherein each of the cells is connected to a circuit, wherein the circuit comprises at least one voltage reference, at least one voltage divider, and at least one operational amplifier, wherein at least one operational amplifier receives a first input from voltage reference and a second input from voltage divider and shunts an output through a resistor when capacitance of cell exceeds the trip point.

According to a fourth broad aspect of the present invention, there is provided a method for accommodating mismatched capacitances of a string of series connected cells comprising the steps of setting a trip point that is lower than maximum rated voltage of the cell, and bleeding energy from the cell when said voltage across the cell exceeds the trip point, wherein each of the cells is connected to a circuit, wherein the circuit comprises at least one voltage source, and a string of series connected cells, wherein each of the cells is connected to a circuit, wherein the circuit comprises at least one voltage reference, which consists of a micro-power reference diode device, which sets a trip point, and a power dissipative device in series that allows for current to flow through the power dissipative device when voltage of a cell exceeds the trip point.

Other objects and features of the present invention will be apparent from the following detailed description of the preferred embodiment.

### BRIEF DESCRIPTION OF THE DRAWINGS

The invention will be described in conjunction with the accompanying drawings, in which:

FIG. 1 is a simplified schematic diagram of an energy storage system having a balancing circuit connected to a cell in a string of cells constructed in accordance with an embodiment of the present invention;

FIG. 2 is a schematic diagram of an energy storage system having a balancing circuit connected to a cell in a string of cells constructed in accordance with an embodiment of the present invention;

FIG. 3 is a schematic diagram of a balancing circuit connected to a cell constructed in accordance with an embodiment of the present invention;

FIG. 4 is a schematic diagram of a balancing circuit with a transistor connected to a cell constructed in accordance with an embodiment of the present invention;

FIG. 5 is a schematic diagram of a simplified balancing circuit connected to a cell constructed in accordance with an embodiment of the present invention; and

FIG. 6 is a semi-logarithmic graph comparing the results of several different methods of balancing an ultracapacitor using an embodiment of the present invention.

### DETAILED DESCRIPTION OF THE PREFERRED EMBODIMENT

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

For the purposes of the present invention, the term “energy storage system” refers to any device that is used to store electrical energy for various applications. An energy storage system may consist of cells connected in series that provide power for an application that uses high peak power demands, but has a low average power draw. Examples of such applications include electric vehicles, hybrid vehicles, stand-alone generators, short-term UPS, etc.

For the purposes of the present invention, the term “cell” refers to any device that may store potential electrical energy. A cell may refer to a battery, voltaic cell, capacitor, ultracapacitor, etc. An ultracapacitor cell may also be referred to as a supercapacitor, double layer capacitor, or electric double layer capacitor (ELDC).

For the purposes of the present invention, the term “voltage reference” refers to a function of a circuit connected to a cell that provides a reference potential for the circuit. Preferably, the value of a voltage reference in a circuit of the present invention may be fixed.

For the purposes of the present invention, the term “trip point” refers to a condition that turns “on” a circuit to bleed energy from a cell in order to maintain balance in a string of cells. The trip point may be set by dividing the cell's voltage using the voltage divider and comparing that value with the voltage reference. According to embodiments of the present invention, a value of the trip point may be set below the cell's maximum rating. Preferably the percent difference in volts of the voltage reference and cell's maximum rating is approximately 0% to 90%.

For the purposes of the present invention, the term “maximum rating” refers to the rating set by the manufacturer of a cell to indicate the highest possible voltage in which a cell may operate.

For the purposes of the present invention, the term “bleed” refers to process for removing energy from a cell at a current greater than or equal to the expected leakage current for a cell. A preferred circuit of the present invention may be used to consume energy from a cell to reduce the voltage of the cell. The term “bleed current” refers to the amount of current that flows through the balancing circuit, which removes energy from and decreases the voltage of a cell. The term “bleed energy” refers to the amount of power dissipated from a cell, which is a function of the bleed current and cell voltage.

For the purposes of the present invention, the term “leakage current” refers to the expected loss of energy from a cell while operating at or below the rated voltage for the cell. Energy may be slowly lost from a cell over a period of time due to leakage current. A cell with a high leakage current will lose energy and decrease its voltage more rapidly. When cells are connected in series, one cell may have a higher leakage current than other cells, which may create a mismatched voltage in the series.

For the purposes of the present invention, the term “power dissipative device” refers to any device capable of dissipating or consuming the bleed energy. Preferably, a resistor, transistor, etc. may be used as a power dissipative device.

### Description

Previous methods and devices for balancing or equalizing the voltage on an individual cell in a series involved passive methods that connect resistors to a cell. The passive methods do not perform well when used for a series of ultracapacitors, due to higher leakage current for ultracapacitors. One reason is that ultracapacitors may have higher leakage currents than resistors can accommodate. The passive method of balancing relies on a constant bleed off of stored energy in order to equalize cell potentials. The common practice is to set a current through the resistor which is approximately 10 times the average leakage current of the cell. This constant bleed of energy drains the cells 10 times more quickly than by leakage current alone.

Previous methods use complex integrated circuits or microprocessors to balance the voltage across cells in a string. The present invention utilizes a simple active balancing circuit and method that may accommodate higher leakage currents found in cells, such as ultracapacitors.

In addition, previous methods use external power or DC-to-DC power converters to provide the power for circuits or devices used for balancing or equalizing the voltage of individual cells in a series. The present invention utilizes the power from the cell directly to power the balancing circuit, reducing system complexity and eliminating the need for external power sources.

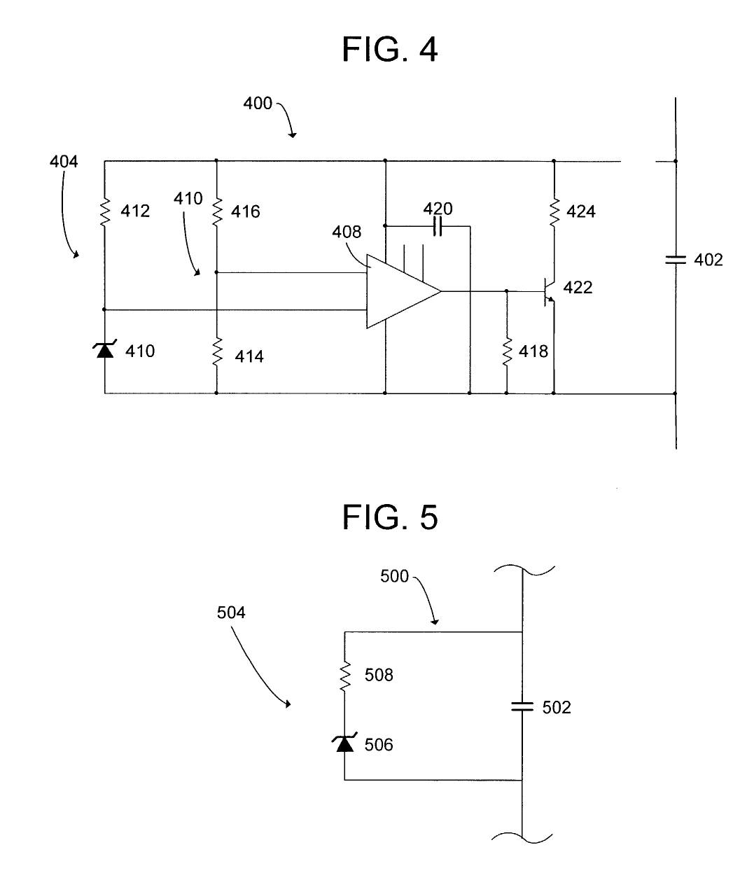

A prior method of equalizing the voltage on an ultracapacitor cell is shown by U.S. Pat. No. 6,265,851, issued to Brien et al., the entire contents and disclosure of which is hereby incorporated by reference. FIG. 4C of the '851 patent shows a cell voltage equalizer. The '851 patent's cell voltage equalizer requires an over-voltage reporter and a controller to monitor any over-voltage conditions that may exist in a cell. In addition, the '851 patent's device attempts to clamp over-voltage by shorting the cell terminals. The trip point for shorting the cell terminals is substantially equal to the maximum rated voltage for the cell. The present invention provides a device for bleeding excess energy from a cell so that the cell may maintain matched parameters with other cells in the series. In addition, the present invention sets a trip point for balancing a cell that may be lower than the maximum rated voltage of the cell.

Similarly, a prior method of equalizing the voltage on a thin-film electrochemical cell is shown by U.S. Pat. No. 5,952,815, issued to Rouillard et al, the entire contents and disclosure of which is hereby incorporated by reference. The '815 patent requires a detector for monitoring voltage conditions and a control signal to respond to the detector. However, the present invention operates to continuously balance the electrical parameters on a cell connected in a series by bleeding excess energy from each cell.

The present invention provides a cell a strong non-linearity in parallel resistance with respect to voltage. One goal of the present invention is to equalize leakage currents from cells connected in a series over the long term and consequently equalize cell potentials or cell voltages.

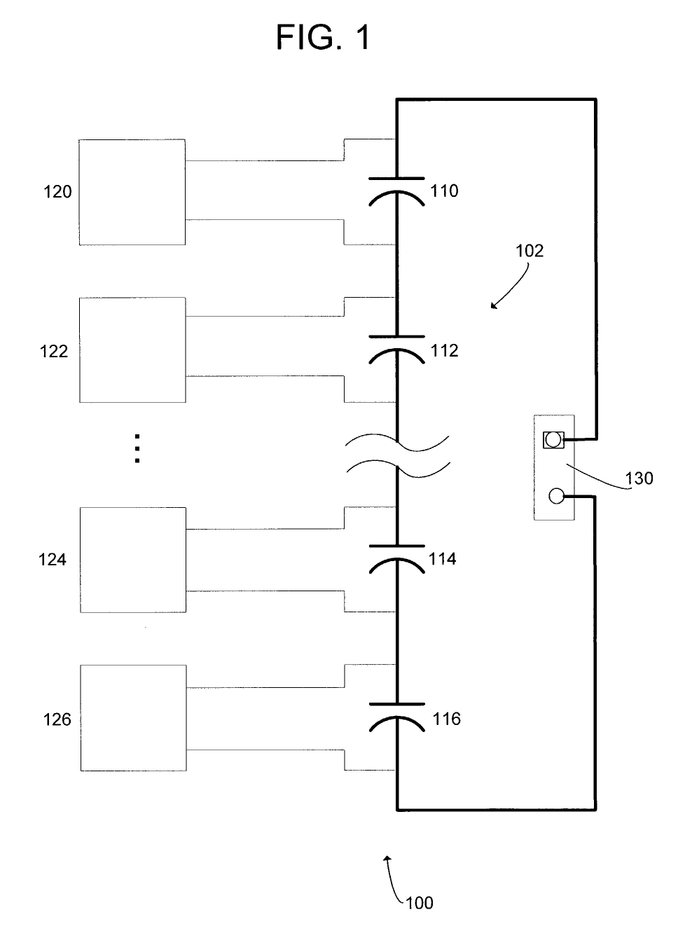

FIG. 1 is a simplified schematic diagram of an energy storage system 100 having a balancing circuit connected to cells in a string of series-connected cells constructed in accordance with the embodiment of the present invention. The energy storage system 100 consists of a string 102 of cell 110, cell 112, cell 114, cell 116 and so on for as many cells are in the series-connected string. Cell 110, cell 112, cell 114, cell 116 and so on are connected to circuit 120, circuit 122, circuit 124, circuit 126 and so on, respectively. String 102 is connected to source 130.

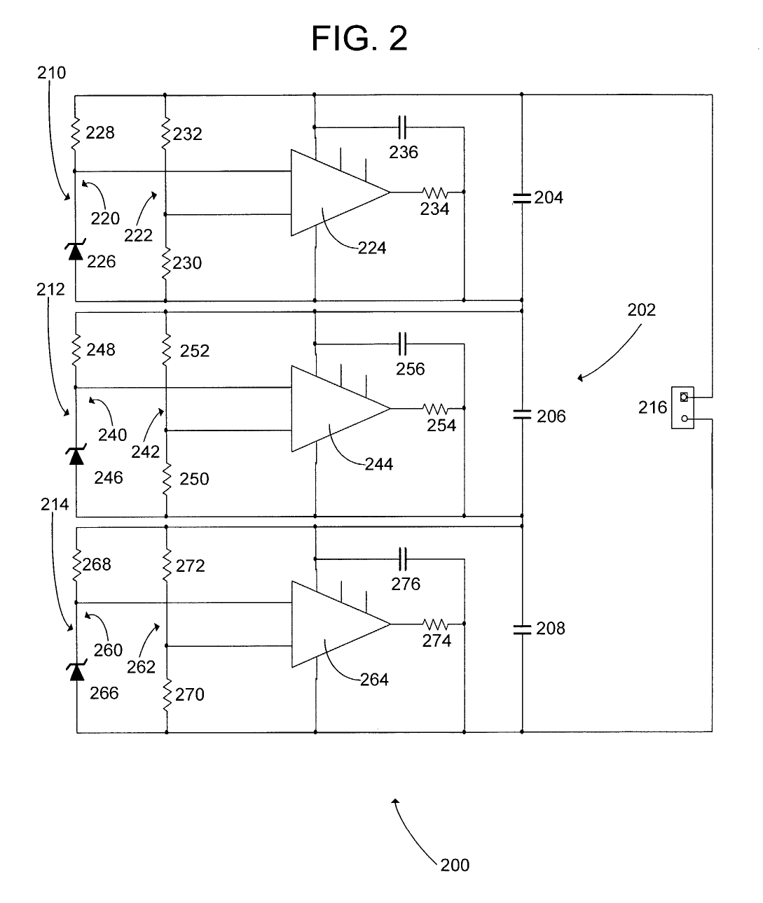

FIG. 2 is a schematic diagram of an energy storage system 200 having a circuit connected to cells in a string of series-connected cells constructed in accordance with an embodiment of the present invention. The energy-storage system 200 consists of a string 202 of cell 204, cell 206, and cell 208 connected in series. Cell 204, cell 206, and cell 208 are connected to circuit 210, circuit 212, and circuit 214, respectively. String 202 is connected to source 216.

In FIG. 2, circuit 210 is connected to cell 204. Circuit 210 comprises a voltage reference 220, voltage divider 222, and operational amplifier (op amp) 224. Voltage reference 220 comprises a micro-power reference diode 226 and resistor 228, which sets a voltage reference for circuit 210. Voltage divider 222 comprises resistor 230 and resistor 232, which divides the voltage from cell 204, and establishes a trip point. Op amp 224 receives an input signal from voltage reference 220 and an input signal from voltage divider 222. Op amp 224 produces an output signal that shunts bleed current through resistor 234. Capacitor 236 is a bypass capacitor for op amp 224.

In FIG. 2, circuit 212 is connected to cell 206. Circuit 212 comprises a voltage reference 240, voltage divider 242, and operational amplifier (op amp) 244. Voltage reference 240 comprises a micro-power reference diode 246 and resistor 248, which sets a voltage reference for circuit 212. Voltage divider 242 comprises resistor 250 and resistor 252, which divides the voltage from cell 206, and establishes a trip point. Op amp 244 receives an input signal from voltage reference 240 and an input signal from voltage divider 242. Op amp 244 produces an output signal that shunts bleed current through resistor 254. Capacitor 256 is a bypass capacitor for op amp 244.

In FIG. 22, circuit 214 is connected to cell 208. Circuit 214 comprises a voltage reference 260, voltage divider 262, and operational amplifier (op amp) 264. Voltage reference 260 comprises a micro-power reference diode 266 and resistor 268, which sets a voltage reference for circuit 214. Voltage divider 262 comprises resistor 270 and resistor 272, which divides the voltage from cell 208, and establishes a trip point. Op amp 264 receives an input signal from voltage reference 260 and an input signal from voltage divider 262. Op amp 264 produces an output signal that shunts bleed current through resistor 274. Capacitor 276 is a bypass capacitor for op amp 264.

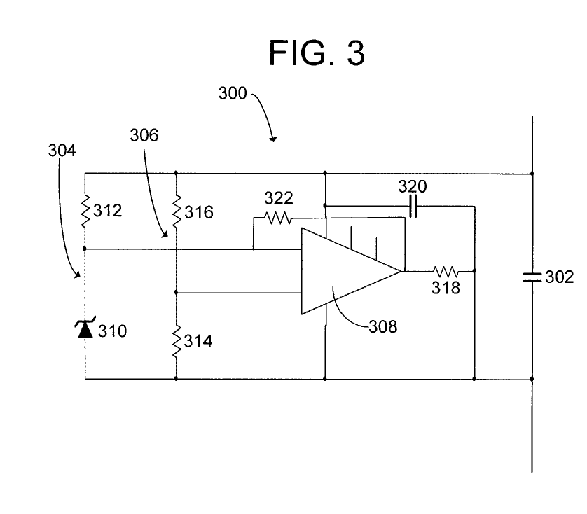

FIG. 3 is a schematic diagram of a balancing circuit 300 connected to a cell 302 constructed in accordance with an embodiment of the present invention. In FIG. 3, circuit 300 is connected to cell 302. Circuit 300 comprises a voltage reference 304, voltage divider 306, and operational amplifier (op amp) 308. Voltage reference 304 comprises a micro-power reference diode 310 and resistor 312, which sets a voltage reference for circuit 300. Voltage divider 306 comprises resistor 314 and resistor 316, which divides the voltage from cell 302, and establishes a trip point. Op amp 308 receives an input signal from voltage reference 304 and an input signal from voltage divider 306. Op amp 308 produces an output signal that shunts bleed current through resistor 318. Capacitor 320 is a bypass capacitor for the supply power for op amp 308. Feedback resistor 322 is adjusted to tune op amp 308 for a variety of gains.

It should be appreciated that an operational amplifier may act as a comparator when no feedback resistor is present.

FIG. 4 is a schematic diagram of a balancing circuit 400 having a transistor connected to a cell 402 constructed in accordance with an embodiment of the present invention. In FIG. 4, circuit 400 is connected to cell 402. Circuit 400 comprises a voltage reference 404, voltage divider 406, and operational amplifier (op amp) 408. Voltage reference 404 comprises a micro-power reference diode 410 and resistor 412, which sets a voltage reference for circuit 412. Voltage divider 406 comprises resistor 414 and resistor 416, which divides the voltage from cell 402, and establishes a trip point. Op amp 408 receives an input signal from voltage reference 404 and an input signal from voltage divider 406. Op amp 408 produces an output signal that shunts bleed current through resistor 418. Capacitor 420 is a bypass capacitor for op amp 408. Transistor 422 and resistor 424 increase the current dissipated in circuit 400 above cell 402's trip point.

FIG. 5 is a schematic diagram of a circuit 500 connected to a cell 502 constructed in accordance with an embodiment of the present invention. In FIG. 5, circuit 500 is connected to cell 502. Circuit 500 comprises a voltage reference 504. Voltage reference 504 comprises a micro-power reference diode 506 and resistor 508.

Preferably, a cell as shown in FIG. 5 is part of a string of series connected cells. Each cell in a string may have a similar circuit to balance the capacitor of each cell. A resistor in a circuit shown in FIG. 5 may have a resistance of approximately 20 Ohm to 60 Ohm. A micro-power reference diode in such a circuit may have a voltage reference that is approximately 1.25 to 2.50 volts. The voltage of the voltage reference preferable remains the same and does not change with the capacitance of the cell.

Preferably, a source for an energy storage system of the present invention may be a voltage source, load or an energy-consuming device. According to an embodiment of the present invention, a string of cells may be connected to such a source.

Preferably, cells in a string according to the present invention may be a battery cell, capacitor cell or an ultracapacitor cell. A combination of different types of batteries, capacitors and/or ultracapacitors may be connected in a string. In addition, cells in a string may have different voltage potentials and/or capacitance.

An embodiment of the present invention may use reverse voltage of a micro-power reference diode device as a voltage reference. Alternatively, a diode or zener diode, or a micro power band-gap voltage regulator diode, may be used in place of a micro-power reference diode device. Using a micro-power reference diode device greatly reduces quiescent power of a circuit. A resistor may be connected to a micro-power reference diode according to an embodiment of the present invention to modify the quiescent power consumption. Such a resistor may have a resistance between 20 Ohm and 100,000 Ohm.

An embodiment of the present invention may use the forward bias threshold of one or more series connected diodes or zener diodes as a voltage reference.

A voltage divider according to the present invention may have at least two resistors to divide terminal voltage from a cell. Since the voltage reference is essentially fixed, the voltage divider sets the voltage trip point for the cell. This trip point may be determined by the composition and construction of the cell as well as certain environmental parameters, especially temperature. Preferably, resistors that are part of the voltage divider may have substantially equal composition, power rating, tolerance and thermal coefficient. The resistors in the voltage divider may have a resistance between 100 Ohm and 10,000,000 Ohm.

The present invention utilizes an operational amplifier (op amp) that can be tuned for a variety of gains by adjusting the value of a feedback resistor. Without a feedback resistor, the op amp may act as a comparator. An op amp may be powered directly from a single cell or a string of series-connected cells. An op amp may be a micropower op amp. An op amp according to the present invention may operate to correct for any mismatched electrical parameter from each cell by dissipating any excess charge from being stored on the cell. An op amp of the present invention may shunt bleed current through a resistor when each cell's voltage exceeds the trip point set by a voltage reference. At least one resistor, or other power dissipative device, may be connected to an op amp to receive the output signal. The power dissipative device or resistor may consume the bleed energy upon receiving the output signal from the op amp. The power dissipative device or resistor bleeds or dissipates excess or unwanted electrical energy from the cell without the need to clamp over-voltage by shorting the cell terminals. Such a resistor may have a resistance between approximately 20 Ohm and 1,000,000 Ohm.

In an alternative embodiment, a comparator may be used instead of an operational amplifier.

Preferably, at least one transistor may be added to a circuit of the present invention to increase the bleed current, which increases the amount of energy dissipated. Also, the value of resistor that receives the bleed current may be lowered to increase the bleed current, thereby increasing the dissipated energy.

A preferred embodiment of the present invention may accommodate additional cells when necessary. There is no limit on the number of cells that may be added in the string to expand the energy storage system. Alternatively, an energy storage system of the present invention may consist of at least two cells. Each additional cell may be connected independently to a circuit of the present invention. Additional cells may be added or removed from a string. Since a circuit of the present invention may be connected independently, the addition or removal of one cell from the string does not impact the entire system.

A circuit of the present invention may function to correct any mismatch in electrical parameters, such as capacitance or leakage current, of each cell connected in series in an energy storage system. A circuit of the present invention dissipates bleed energy from each cell. Preferably, the present invention may bleed off excess energy when any cell exceeds the voltage trip point. This trip point is determined by the composition and construction of the cell as well as certain environmental parameters especially temperature. Adjusting the resister values of the voltage divider may set a voltage trip point of the present invention. The voltage divider output is compared to a voltage reference. When a cell voltage reaches a level, which exceeds the trip point, energy, in the form of bleed current, may be dissipated by the present invention, thus lowering the cell voltage. Alternatively, adding or altering a resistor connected to such a micro-power reference diode device may adjust the trip point.

The voltage trip point selected is dependant on a cell's maximum rating with derating for cycle life, duty cycle, and thermal environment. Preferably, a voltage trip point may be substantially equal to or lower than a cell's maximum rated voltage. Dissipating bleed current may give each cell a strong non-linearity in parallel resistance with respect to voltage. Over a period of time, a circuit of the present invention may tend to equalize each cell's voltage potential and, in turn, equalize the effective leakage currents of cells connected in series. Bleed current may be several times higher than the expected leakage current for a cell. By bleeding excess energy, the present invention corrects and accommodates mismatch in electrical parameters that may exist in energy storage systems.

A circuit of the present invention may bleed excessive energy from a cell while having an extremely low quiescent power draw. A larger quiescent power draw would increase the self-discharge characteristics of a capacitor based energy storage system. Preferably, quiescent power draw of the present invention is less than fifty microamperes. More preferably, quiescent power draw of the present invention is less than twenty microamperes.

In addition, circuits of the present invention may bleed energy from each cell connected in a series independently to achieve a balance between cells. Typically, cells may have inherent variations that may give cells with the same nominal energy capacity different cell voltages. The present invention allows specific mismatches in electrical parameters, such as capacitance and leakage current, in an individual cell connected to other cells with the same energy capacity. A circuit of the present invention may bleed energy from each cell as needed to remove excessive energy on one cell without affecting the other cells in the series. By correcting mismatches in electrical parameters of each cell in a string of cells the present invention may eliminate the need to select cells with precisely matched electrical parameters when constructing a string of cells.

A circuit of the present invention may operate to balance electrical parameters at any time during the charging/discharging or resting of a string of cells.

The present invention may significantly reduce the number of components associated with balancing cells by eliminating the need for switching devices, bipolar transistors, MOSFETs (metal-oxide semiconductor field effect transistors), etc. By reducing the number of components, the complexity and the cost of the circuit of the present invention may be reduced by ten to fifty times over prior methods.

The present invention may be used in many applications, including but not limited to applications for stand-alone power generators, short-term UPS, power grid hold-ups, energy storage devices for electrical propulsion for vehicles, components within vehicles, such as electrical accessories, power steering, power windows, and any application having an interconnection of capacitors and/or ultracapacitors where there is high peak demand in a system that typically has a low average demand.

### EXAMPLE I

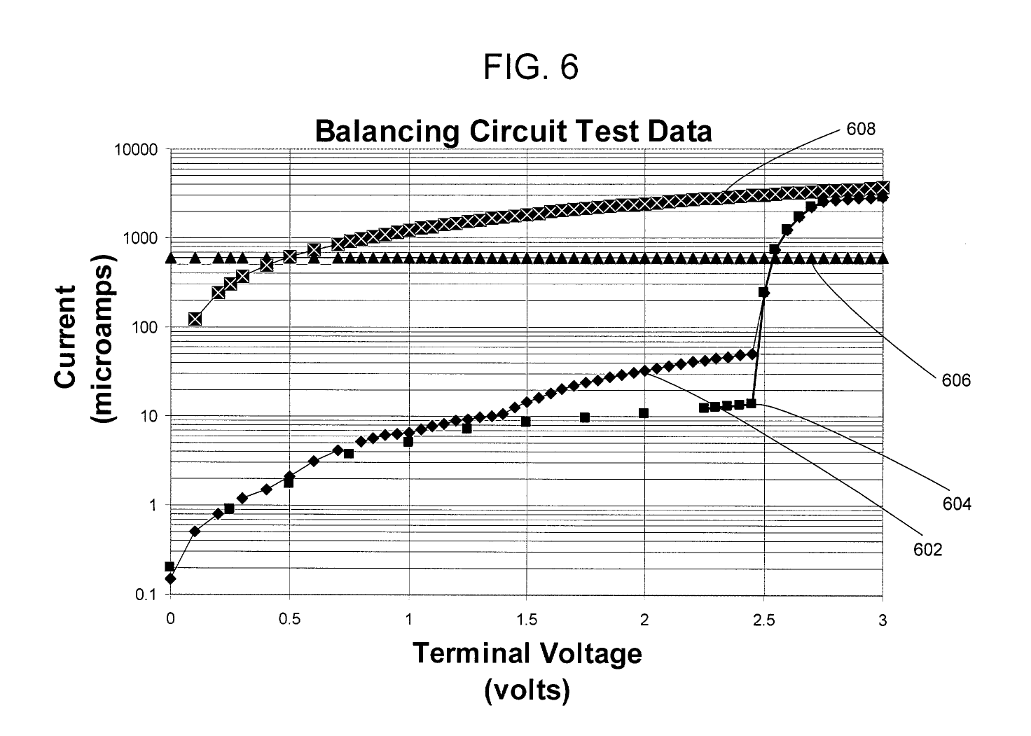

A test using a preferred embodiment of the present invention as shown in FIG. 2, produced an ultracapacitor balancing circuit that reduced leakage as shown in FIG. 6. The following values, associated with FIG. 2, are shown in Table 1.

TABLE 1
Parameters for Circuit

| | |
|---|---|
| Cell 204 | 100 Farad, 2.7 volt ultracapacitor cell |
| Micro-Power Voltage Diode 226 | 1.22 volts |
| Resistor 228 | 27 kohm |
| Resistor 230 | 510 kohm |
| Resistor 232 | 510 kohm |
| Resistor 234 | 620 ohm |
| Capacitor 236 | 1 μ Farad |

The values for each circuit attach to the cells in FIG. 2 are the same as shown in Table 1 for the present example.

FIG. 6 is a chart that shows the results of test data for a number of different circuits and methods for balancing the capacitance on a cell. Line plot 602 represents data for an initial test using a preferred embodiment of the present invention. Line plot 604 represents data results for a refined test using a preferred embodiment of the present invention after the values of the resistors in the circuit were adjusted. The adjusted resistor values for the refined test are shown in Table 2.

TABLE 2
Adjusted Parameters for Circuit

| | |
|---|---|
| Cell 204 | 100 Farad, 2.7 volt ultracapacitor cell |
| Micro-Power Voltage Diode 226 | 1.22 volts |
| Resistor 228 | 60 kohm |
| Resistor 230 | 510 kohm |
| Resistor 232 | 510 kohm |
| Resistor 234 | 620 ohm |
| Capacitor 236 | 1 μ Farad |

Line plot 606 represents typical ultracapacitor leakage data or rated voltage for a 100 Farad ultracapacitor. Line plot 608 represents data from a passive method that places a resistor value across the ultracapacitor cell terminals. Line plot 608 results in a leakage current that is ten times the maximum rated voltage for a 100 Farad ultracapacitor.

As shown by the results in FIG. 6, line plot 602 and line plot 604, resulted in an extremely low quiescent current of less than 50 μA.

### EXAMPLE II

A test using a preferred embodiment of the present invention, as shown in FIG. 4, produced an ultracapacitor balancing circuit that reduced the effective leakage current of cells connected in a series. The following values used in FIG. 4, are shown in Table 3.

TABLE 3
Parameters for Circuit

| | |
|---|---|
| Cell 402 | 2500 Farad, 2.7 volt ultracapacitor cell |
| Micro-Power Voltage Diode 410 | 1.25 volts |
| Resistor 412 | 150 kohm |
| Resistor 414 | 499 kohm |
| Resistor 416 | 499 kohm |
| Resistor 418 | 10 kohm |
| Transistor 422 | NPN Transistor |
| Resistor 424 | 20 ohm |
| Capacitor 420 | 100 n Farad |

All documents, patents, journal articles and other materials cited in the present application are hereby incorporated by reference.

Although the present invention has been fully described in conjunction with the preferred embodiment thereof with reference to the accompanying drawings, it is to be understood that various changes and modifications may be apparent to those skilled in the art. Such changes and modifications are to be understood as included within the scope of the present invention as defined by the appended claims, unless they depart there from.

What is claimed is:

1. An energy storage system comprising:
at least one voltage source; and
a string of series connected cells, wherein each of said cells is connected to a circuit, wherein said circuit comprises:
at least one voltage reference;
at least one voltage divider, which establishes a trip point; and
at least one operational amplifier, wherein said at least one operational amplifier receives a first input from said voltage reference and a second input from said voltage divider and shunts an output through a power dissipative device when voltage of said cell exceeds said trip point.

2. The energy storage system of claim 1, wherein said at least one voltage reference comprises a micro-power reference diode and a first resistor.

3. The energy storage system of claim 2, wherein said micro-power reference diode is a zener diode.

4. The energy storage system of claim 2, wherein said micro-power reference diode is a micro power band-gap voltage regulator diode.

5. The energy storage system of claim 2, wherein said micro-power reference diode is a series of one or more forward biased diodes.

6. The energy storage system of claim 2, wherein said micro-power reference diode produces a reverse voltage threshold to set said trip point.

7. The energy storage system of claim 1, wherein said trip point is set below the maximum rated voltage of said cell.

8. The energy storage system of claim 1, wherein the percent difference in volts between said trip point and said maximum rated voltage of said cell is approximately 0% to 90% below said maximum rated voltage of said cell.

9. The energy storage system of claim 1, wherein said voltage divider comprises a second resistor and a third resistor having substantially equal composition, power rating, tolerance and thermal coefficients.

10. The energy storage system of claim 1, wherein said circuit has a quiescent power draw from said cell of less than fifty microamperes.

11. The energy storage system of claim 10, wherein said circuit has a quiescent power draw from said cell of less than twenty microamperes.

12. The energy storage system of claim 1, wherein said power dissipative device comprises a fourth resistor.

13. The energy storage system of claim 12, wherein said power dissipative device comprises at least one transistor, wherein said transistor increases the current and the energy dissipation of said power dissipative device.

14. The energy storage system of claim 1, wherein said cell is a capacitor.

15. The energy storage system of claim 1, wherein said cell is an ultracapacitor.

16. The energy storage system of claim 1, wherein said output is a bleed current.

17. The energy storage system of claim 16, wherein said bleed current is substantially higher than the expected leakage current of said cell.

18. The energy storage system of claim 1, wherein said string of series connected cells comprises at least two cells.

19. The energy storage system of claim 1, wherein said circuit further comprises a feedback resistor for said at least one operational amplifier.

20. The energy storage system of claim 1, wherein said circuit is powered from said cell.

21. An energy storage system comprising:
at least one voltage source; and
a string of series connected cells, wherein each of said cells is connected to a circuit, wherein said circuit comprises:
at least one voltage reference;
at least one voltage divider, which establishes a trip point; and
at least one comparator, wherein said at least one comparator receives a first input from said voltage reference and a second input from said voltage divider and shunts an output through a power dissipative device when voltage of said cell exceeds said trip point.

22. The energy storage system of claim 21, wherein said at least one voltage reference comprises a micro-power reference diode and a first resistor.

23. The energy storage system of claim 22, wherein said micro-power reference diode is a zener diode.

24. The energy storage system of claim 22, wherein said micro-power reference diode is a series of one or more forward biased diodes.

25. The energy storage system of claim 22, wherein said micro-power reference diode is a micro power band-gap voltage regulator diode.

26. The energy storage system of claim 22, wherein said micro-power reference diode produces a reverse voltage threshold to set said trip point.

27. The energy storage system of claim 21, wherein said trip point is set below the maximum rated voltage of said cell.

28. The energy storage system of claim 21, wherein the percent difference in volts between said trip point and said maximum rated voltage of said cell is approximately 0% to 90% below said maximum rated voltage of said cell.

29. The energy storage system of claim 21, wherein said voltage divider comprises a second resistor and a third resistor having substantially equal composition, power rating, tolerance and thermal coefficients.

30. The energy storage system of claim 21, wherein said circuit has a quiescent power draw from said cell of less than fifty microamperes.

31. The energy storage system of claim 30, wherein said circuit has a quiescent power draw from said cell of less than twenty microamperes.

32. The energy storage system of claim 21, wherein said power dissipative device comprises a fourth resistor.

33. The energy storage system of claim 32, where in said power dissipative device further comprises at least one transistor, wherein said transistor increases the current and the energy dissipation of said power dissipative device.

34. The energy storage system of claim 21, wherein said cell is a capacitor.

35. The energy storage system of claim 21, wherein said cell is an ultracapacitor.

36. The energy storage system of claim 21, wherein said output is a bleed current.

37. The energy storage system of claim 36, wherein said bleed current is substantially higher than the expected leakage current of said cell.

38. The energy storage system of claim 21, wherein said string of series connected cells comprises at least two cells.

39. The energy storage system of claim 21, wherein said circuit is powered from said cell.

40. A method for accommodating mismatched capacitance of a string of series connected cells comprising the following steps:
providing a trip point that is lower than a maximum rated voltage of said cell; and
bleeding energy from said cell, when said voltage across said cell exceeds said trip point, by using a circuit that comprises:
at least one voltage reference;
at least one voltage divider, which establishes a trip point; and
at least one operational amplifier, wherein said at least one operational amplifier receives a first input from said voltage reference and a second input from said voltage divider and shunts an output bleed current through a power dissipative device when voltage of said cell exceeds said trip point so that said voltage of said string of series connected cells remains in balance.

41. The method of claim 40, wherein the percent difference in volts between said trip point and said maximum rated voltage of said cell is approximately 0% to 90% below said maximum rated voltage of said cell.

42. The method of claim 40, wherein said string of series connected cells comprises at least a first cell and second cell.

43. The method of claim 42, wherein the capacitance of said first cell matches the capacitance of said second cell.

44. The method of claim 40, wherein said first current is higher than the expected leakage current for said cell.

45. The method of claim 40, wherein said at least one voltage reference comprises a micro-power reference diode and a first resistor.

46. The method of claim 45, wherein said micro-power reference diode is a zener diode.

47. The method of claim 45, wherein said micro-power reference diode is a micro power band-gap voltage regulator diode.

48. The method of claim 45, wherein said micro-power reference diode is a series of one or more forward biased diodes.

49. The method of claim 45, wherein said micro-power reference diode produces a reverse voltage threshold that to set said trip point.

50. The method of claim 40, wherein said voltage divider comprises a second resistor and a third resistor having substantially equal composition, power rating, tolerance and thermal coefficients.

51. The method of claim 40, wherein said circuit has a quiescent power draw from said cell of less than fifty microamperes.

52. The method of claim 40, wherein said circuit has a quiescent power draw from said cell of less than twenty microamperes.

53. The energy storage system of claim 40, wherein said power dissipative device comprises a fourth resistor.

54. The method of claim 40, wherein said power dissipative device further comprises at least one transistor, wherein said transistor increases the current and the energy dissipation of said power dissipative device.

55. The method of claim 40, wherein said cell is a capacitor.

56. The method of claim 40, wherein said cell is an ultracapacitor.

57. The method of claim 40, wherein said circuit is powered from said cell.

58. The method of claim 40, wherein said operational amplifier is a comparator.

59. A method for balancing capacitance of a string of series connected cells comprising the following steps:
providing a trip point that is lower than a maximum rated voltage of said cell; and
bleeding energy from said cell when said voltage across said cell exceeds said trip point, by using a circuit that comprises:
at least one voltage reference for establishing said trip point; and
a power dissipative device for shunting an output through said power dissipative device when voltage of said cell exceeds said trip point so that said voltage of said string of series connected cells remains in balance, wherein said power dissipative device is connected in series with said at least one voltage reference.

60. The method of claim 59, wherein the percent difference in volts between said trip point and said maximum rated voltage of said cell is approximately 0% to 90% below said maximum rated voltage of said cell.

61. The method of claim 59, wherein said string of series connected cells comprises at least a first cell and second cell.

62. The method of claim 61, wherein the capacitance of said first cell matches the capacitance of said second cell.

63. The method of claim 59, wherein said first current is higher than the expected leakage current for said cell.

64. The method of claim 59, wherein said at least one voltage reference comprises a micro-power reference diode.

65. The method of claim 64, wherein said micro-power reference diode is a zener diode.

66. The method of claim 64, wherein said micro-power reference diode is a micro power band-gap voltage regulator diode.

67. The method of claim 64, wherein said micro-power reference diode is a series of one or more forward biased diodes.

68. The method of claim 64, wherein said micro-power reference diode produces a reverse voltage threshold that to set said trip point.

69. The method of claim 59, wherein said circuit has a quiescent power draw from said cell of less than fifty microamperes.

70. The method of claim 59, wherein said circuit has a quiescent power draw from said cell of less than twenty microamperes.

71. The method of claim 59, wherein said power dissipative device further comprises at least one transistor, wherein said transistor increases the current and the energy dissipation of said power dissipative device.

72. The method of claim 59, wherein said cell is a capacitor.

73. The method of claim 59, wherein said cell is an ultracapacitor.

74. The method of claim 59, wherein said circuit is powered from said cell.
